(19) United States
(12) Patent Application Publication
(10) Pub. No.: US 2007/0131518 A1
(43) Pub. Date: Jun. 14, 2007

(54) Apparatus for changing position of and carrying wheel

(76) Inventor: Hoon Son, Cheonan-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/524,929

(22) Filed: Sep. 21, 2006

(30) Foreign Application Priority Data
Dec. 12, 2005 (KR) 10-2005-0121453

(51) Int. Cl. B65G 47/24

(52) U.S. Cl. 198/406

(57) ABSTRACT

An apparatus for changing a position of and carrying a wheel has a structure such that manipulation for changing the position of the wheel from a horizontal state into a vertical state in a wheel mounting process in a vehicle assembly line is simplified and a process of carrying the wheel to a subsequent process can be easily conducted. Embodiments of the apparatus include an advancing conveyor, a position-changing device, and a carrying device.

### CROSS-REFERENCE TO RELATED APPLICATIONS

The present application is based on, and claims priority from, Korean Application Serial Number 10-2005-0121453, filed on Dec. 12, 2005, the disclosure of which is hereby incorporated by reference herein in its entirety.

### FIELD OF THE INVENTION

The present invention relates to apparatuses for changing positions of and carrying wheels and, more particularly, to an apparatus used in a vehicle assembly line for automatically changing the position of a wheel from a horizontal state to a vertical state, and for carrying the wheel to a mounting process.

### BACKGROUND OF THE INVENTION

Generally, when an object is automatically carried by a carrying device such as a conveyor, it may be necessary to change the direction in which the object is moved or to change the position of the object by an angle of 90°, that is, from a horizontal state to a vertical state or from a vertical state to a horizontal state.

To achieve the above purpose, an apparatus for changing a position of a wheel was proposed in Japan Utility Model Laid-open Publication No. Heisei. 6-54638. In this wheel position-changing apparatus, an L-shaped bucket, which supports a wheel supplied to the wheel position-changing apparatus, is provided to be rotatable from a vertical state to a horizontal state by a bucket-actuating cylinder. At least one flap is provided at a predetermined position on the bottom of the bucket. The flap is rotated between the bottom and an upright position by a flap actuating cylinder. Thus, while the flap is folded into the bottom of the bucket, the wheel is rolled and placed in the bottom of the bucket. The wheel is brought into contact with a stopper. Then, the flap is rotated to the upright position by the flap actuating cylinder, thus preventing the wheel from rolling. Thereafter, the bucket is rotated by the bucket actuating cylinder, thereby changing the position of the wheel from a vertical state to a horizontal state.

However, in the conventional wheel position-changing apparatus, in the process of placing the wheel in the bottom of the bucket, because a worker must place the wheel in the bucket using his/her hands, it is very inconvenient, and workability is reduced. Furthermore, the conventional wheel position-changing apparatus cannot be directly used in a vehicle assembly line, in which wheels are supplied to a wheel mounting process. To use the conventional wheel position-changing apparatus in the vehicle assembly line, a separate vertical position-changing device and carrying device are required. Therefore, expenses increase and relatively large space is required to install the apparatus.

### SUMMARY OF THE INVENTION

Embodiments of the present invention provide apparatus for changing the position of and carrying a wheel, which has a structure such that manipulation of changing the position of the wheel from a horizontal state to a vertical state in a wheel mounting process in a vehicle assembly line is simplified and a process of carrying the wheel to a subsequent process is easily conducted.

An apparatus for changing a position of and carrying a wheel according to an exemplary embodiment of the present invention includes an advancing conveyor. The advancing conveyor has a frame. Roller support bars are provided on an upper end of the frame at positions spaced apart from each other by a predetermined distance. A plurality of carrying rollers is horizontally provided between the roller support bars and operated in conjunction with each other by a motor. A plurality of guide rollers is vertically provided on the roller support bar that is disposed at an outermost position. A position-changing device has a base plate, which is provided on a side surface of the frame. A support shaft is provided on the base plate. A support plate is coupled to the support shaft through a bracket. At least two rotating bars are mounted to the support plate such that the rotating bars are placed between the carrying rollers. A plurality of tread support rollers is provided on the support plate such that the tread support rollers are supported by the roller support bar, which is disposed at an inner position. The tread support rollers are perpendicular to the two rotating bars. A link is coupled to the support shaft. A position-changing cylinder is installed in the frame and coupled to the link so that the tread support rollers and the two rotating bars are rotated at an angle of 90° by the position-changing cylinder. A carrying means has a plurality of wheel side support rollers, which are vertically provided on the base plate around an outer edge of the base plate. A pusher is provided on a support pole placed ahead of the base plate.

### BRIEF DESCRIPTION OF THE DRAWINGS

For a better understanding of the nature and objects of the present invention, reference should be made to the following detailed description with the accompanying drawings, in which:

FIG. 1 is a perspective view of an apparatus for changing a position of and carrying a wheel, according to an embodiment of the present invention;

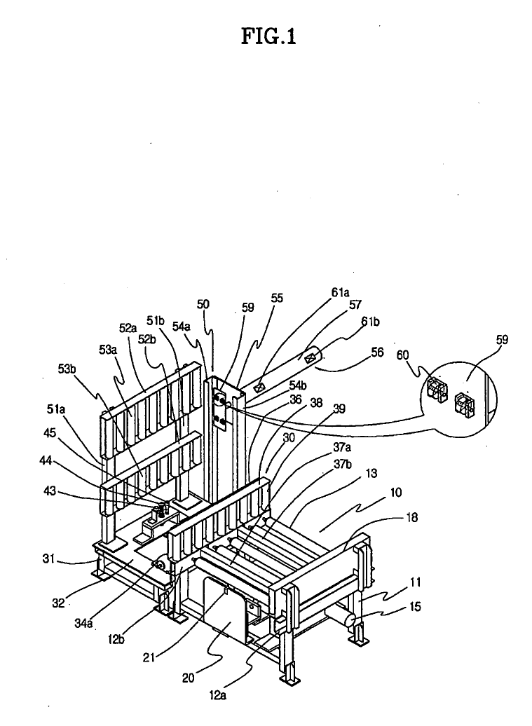

FIG. 2 is a plan view of the apparatus of FIG. 1;

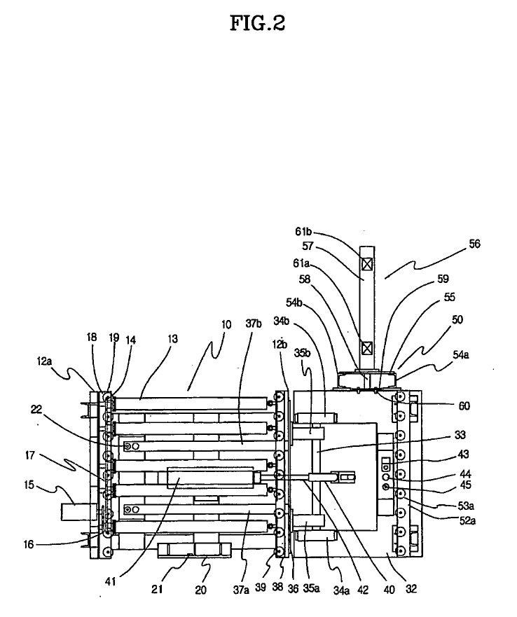

FIG. 3 is a side view of the apparatus of FIG. 1; and

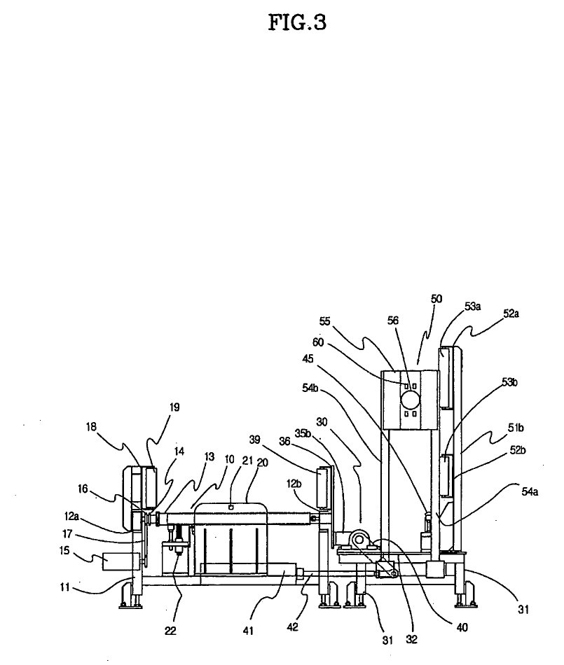

FIG. 4 is a view showing the operation of a position-changing device of the apparatus of FIG. 1.

### DETAILED DESCRIPTION OF THE PREFERRED EMBODIMENTS

Hereinafter, an exemplary embodiment of the present invention will be described in detail with reference to the attached drawings.

In the drawings, the reference numeral 10 denotes an advancing conveyor. In the advancing conveyor 10, roller support bars 12a and 12b are provided on an upper end of a rectangular frame 11 at positions spaced apart from each other by a predetermined distance, and a plurality of carrying rollers 13 is provided between the roller support bars 12a and 12b. Furthermore, a sprocket 14 is provided on an end of each carrying roller 13. A geared motor 15 is mounted to the frame 11 at a position adjacent to the roller support bar 12a, and a sprocket 16 is provided on the carrying roller 13, which is disposed just above the geared motor 15. The sprockets 14, the geared motor 15 and the sprocket 16 are coupled to each other using chains such that they are operated in conjunction with each other. A support member 18 is provided on the roller support bar 12a, and a plurality of guide rollers 19 is installed in the support member 18.

Furthermore, a stop plate 20 is vertically provided behind a downstream end of the carrying rollers 13 in the frame 11. An approach or contact sensor 21 is provided on the stop plate 20, so that when a wheel, which has been carried by the carrying rollers 13 in a horizontal position, is brought into contact with the stop plate 20, an output signal of the sensor 21 controls the geared motor 15.

In the drawings, the reference numeral 30 denotes a position-changing device. In the position-changing device 30, a frame 31 is mounted to the surface of the frame 11, and a base plate 32 is placed on the upper surface of the frame 31. A support shaft 33 is supported at opposite ends thereof on the base plate 32 through bearings 34a and 34b. A support plate 36 is coupled to the support shaft 33 through brackets 35a and 35b. At least two rotating bars 37a and 37b are perpendicularly coupled to the support plate 36 between the carrying rollers 13 such that upper surfaces of the rotating bars 37a and 37b are below upper surfaces of the carrying rollers 13. Furthermore, a support member 38 is provided on the support plate 36. A plurality of tread support rollers 39 is provided in the support member 38 in a direction perpendicular to the rotating bars 37a and 37b, so that when the rotating bars 37a and 37b are horizontal, the tread support rollers 39 face the guide rollers 19 and are at the same height as the guide rollers 19. In addition, the tread support rollers 39 serve to support the tread of the wheel.

Furthermore, a link 40 is securely coupled to the support shaft 33 and is coupled to an actuating rod 42 of a position-changing cylinder 41, which is installed in the frame 11. An approach or contact sensor 43, a shock absorber 44 and a sag prevention stopper 45 are provided on the base plate 32 at a predetermined position corresponding to the position of the support plate 36 when it is rotated in a horizontal direction. Therefore, when a wheel is detected by the sensor 21, which is provided in the stop plate 20, the geared motor 15 is stopped by an output signal of the sensor 21 and, simultaneously, the position-changing cylinder 41 of the position-changing device 30 is operated. Thus, the rotating bars 37a and 37b are stood upright, while the tread support rollers 39 are oriented in horizontal directions. Then, the wheel, which has been in a horizontal state, enters a state of standing vertically. Furthermore, when the support plate 36 and the tread support rollers 39 are converted to horizontal states, the support plate 36 approaches or contacts the sensor 43. At this time, the position-changing cylinder 41 is stopped by an output signal of the sensor 43, and the wheel maintains the state of standing upright.

In the drawings, the reference numeral 50 denotes a carrying means. The carrying means 50 includes support members 52a and 52b, which are provided at upper and lower positions on support rods 51a and 51b which are provided on the surface of the base plate 32, and a plurality of wheel side support rollers 53a and 53b, which are respectively installed in the support members 52a and 52b in vertical directions. Preferably, heights of the wheel side support rollers 53a and 53b can be adjusted by a structure in which slots are formed in the support rods 51a and 51b or in the support members 52a and 52b and the support members 52a and 52b are movably coupled to the support rods 51a and 51b using bolts fitted into the slots. As such, thanks to the structure by which the heights of the wheel side support rollers 53a and 53b can be adjusted, the present invention can carry wheels having various diameters without damaging rims of the wheels.

Meanwhile, support rods 54a and 54b are provided ahead of an upstream end of the base plate 32, and a support plate 55 is provided at an upper position on the support rods 54a and 54b. A pusher 56 is mounted to the support plate 55. The pusher 56 includes a pneumatic cylinder 57, a pushing plate 59, which is coupled to an actuating rod 58 of the pneumatic cylinder 57, and a plurality of rollers 60, which are provided on the pushing plate 59. The pusher 56 is controlled by the sensor 43. Furthermore, actuating rod position detecting switches 61a and 61b, which control the stroke of the actuating rod 58, are provided in the pneumatic cylinder 57.

When the rollers 60 push the wheel, the rollers 60 are in rolling contact with the tire of the wheel, so that the pushing operation can be conducted more smoothly.

In the drawings, the reference numeral 22 denotes a sag prevention stopper.

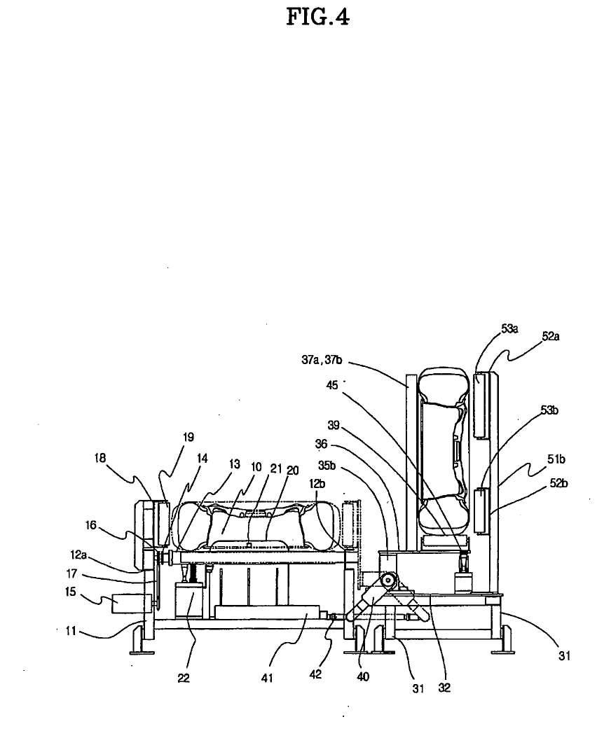

When a wheel enters the advancing conveyor 10 in the state in which the rotating bars 37a and 37b are horizontal, the tread support rollers 39 are vertical, and the pusher 56 is in a retracted state, the wheel is carried on the carrying rollers 13 by the operation of the motor 15 in a horizontal state under the guide of the guide rollers 19 and the tread support rollers 39. When the wheel is moved to the stop plate 20, the sensor 21, which is provided on the stop plate 20, detects the wheel and stops the motor 15 using an output signal thereof. Simultaneously, the actuating rod 42 of the position-changing cylinder 41 is retracted backwards. Then, the rotating bars 37a and 37b are rotated and stood upright, and the tread support rollers 39 are rotated and oriented in a horizontal direction. As such, when the position-changing device 30 conducts the position-changing process, the shock absorber 44 serves to prevent noise, and the sag prevention stopper 22 prevents the wheel from excessively rotating. Furthermore, when the support plate 36, in which the tread support rollers 39 are installed, is oriented in a horizontal direction, the sensor 43 detects this and stops the position-changing cylinder 41 using an output signal thereof. The wheel remains in the vertical state (see, FIG. 4).

As well, when the wheel is changed into the vertical state, the actuating rod 58 of the pusher 56 is advanced by the output signal of the sensor 43 to carry the wheel towards a subsequent conveyor. After a process of carrying the wheel has been completed, the pusher 56 is retracted backwards and then the position-changing cylinder 41 is advanced by the sequence control of a programmable logic controller (PLC). Then, the tread support rollers 39 enter the vertical state, and the rotating bars 37a and 37b are returned to the horizontal state, thus preparing for the conveyance of a subsequent wheel.

As such, the position-changing device 30 is provided around a downstream end of the advancing conveyor 10, that is, a wheel is automatically carried to the position-changing device 30 at the downstream end of the advancing conveyor 10. Therefore, a process of carrying the wheel to the position-changing device 30 is simplified, thus workability thereof is enhanced. Furthermore, the pusher 56 is provided ahead of an upstream end of the position-changing device 30, so that the wheel can be moved to the subsequent conveyor just after the position of the wheel is changed. Accordingly, the structure of the apparatus is simplified, and the space required to install the apparatus is reduced.

As is apparent from the foregoing, in an apparatus for changing the position of and carrying a wheel according to the present invention, a position-changing device is provided around the downstream end of an advancing conveyor, and a pusher is provided ahead of the upstream end of the position-changing device, so that an operation of changing the position of the wheel, which has been carried in a horizontal state, to a vertical state is simplified, thus workability thereof is enhanced. Furthermore, the wheel can be moved to a subsequent conveyor just after the position of the wheel is changed. Accordingly, the structure of the apparatus is simplified, and the space required to install the apparatus is reduced, thus expense is reduced.

What is claimed is:

1. An apparatus for changing a position of and carrying a wheel, comprising:
an advancing conveyor, comprising a frame, roller support bars provided on an upper end of the frame at positions spaced apart from each other by a predetermined distance, a plurality of carrying rollers horizontally provided between the roller support bars and operated in conjunction with each other by a motor, and a plurality of guide rollers vertically provided on the roller support bar that is disposed at an outermost position;
a position-changing device, comprising a base plate provided on a side surface of the frame, a support shaft provided on the base plate, a support plate coupled to the support shaft through a bracket, at least two rotating bars mounted to the support plate such that the rotating bars are placed between the carrying rollers, a plurality of tread support rollers provided on the support plate such that the tread support rollers are supported by the roller support bar, which is disposed at an inner position, the tread support rollers being perpendicular to the two rotating bars, a link coupled to the support shaft, a position-changing cylinder installed in the frame and coupled to the link so that the tread support rollers and the two rotating bars are rotated at an angle of 90° by the position-changing cylinder; and
carrying means, comprising a plurality of wheel side support rollers vertically provided on the base plate around an outer edge of the base plate, and a pusher provided on a support pole placed ahead of the base plate.

2. The apparatus as defined in claim 1, wherein the two rotating bars are disposed below the carrying rollers.

3. The apparatus as defined in claim 1, wherein the wheel side support rollers comprise a plurality of wheel side support rollers, which are vertically provided in each of support members that are mounted at upper and lower positions to a support pole, provided on the base plate at a position adjacent to the outer edge of the base plate.

4. The apparatus as defined in claim 1, wherein a shock absorber and a sag prevention stopper are provided on the base plate at positions corresponding to the support plate when the position of the wheel is changed.

5. An apparatus for changing a position of and carrying a wheel, comprising:
a frame;
roller support bars provided on an upper end of the frame at positions spaced apart from each other by a predetermined distance;
a plurality of carrying rollers horizontally provided between the roller support bars and operated in conjunction with each other by a motor;
a plurality of guide rollers vertically provided on the roller support bar that is disposed at an outermost position;
a base plate provided on a side surface of the frame;
a support shaft provided on the base plate;
a support plate coupled to the support shaft through a bracket;
at least two rotating bars mounted to the support plate such that the rotating bars are placed between the carrying rollers;
a plurality of tread support rollers provided on the support plate such that the tread support rollers are supported by the roller support bar, which is disposed at an inner position, the tread support rollers being perpendicular to the two rotating bars;
a link coupled to the support shaft;
a position-changing cylinder installed in the frame and coupled to the link so that the tread support rollers and the two rotating bars are rotated at an angle of 90° by the position-changing cylinder;
a plurality of wheel side support rollers vertically provided on the base plate around an outer edge of the base plate; and
a pusher provided on a support pole placed ahead of the base plate.
